(19) United States
(12) Patent Application Publication
(10) Pub. No.: US 2020/0391534 A1
(43) Pub. Date: Dec. 17, 2020

(54) PSEUDO ETCHING DECORATION METHOD AND PSEUDO ETCHING DECORATION PRODUCT

(71) Applicant: MIMAKI ENGINEERING CO., LTD., Nagano (JP)

(72) Inventor: Keisuke Suda, Nagano (JP)

(73) Assignee: MIMAKI ENGINEERING CO., LTD., Nagano (JP)

(21) Appl. No.: 16/898,454

(22) Filed: Jun. 11, 2020

(30) Foreign Application Priority Data
Jun. 14, 2019 (JP) 2019-111140

(51) Int. Cl. B41M 5/00

(52) U.S. Cl. CPC B41M 5/0011

(57) ABSTRACT

A pseudo etching decoration method and a pseudo etching decoration product in which decoration that appears as if a decoration target is etched can be provided to the decoration target without actually performing etching are provided. The pseudo etching decoration method includes: a process (S51) of providing a matte-tone coating to the decoration target; and a process (S52) of forming a gloss-tone film of clear ink on part of the surface of the decoration target by providing gloss-tone printing with the clear ink by UV ink-jet printing on part of the matte-tone coating provided to the decoration target in the process at S51.

### CROSS REFERENCE TO RELATED APPLICATIONS

This application claims the priority benefit of Japanese Patent Application No. 2019-111140, filed on Jun. 14, 2019. The entirety of the above-mentioned patent application is hereby incorporated by reference herein and made a part of this specification.

### TECHNICAL FIELD

The present disclosure relates to a pseudo etching decoration method and a pseudo etching decoration product in which decoration that appears as if a decoration target is etched is provided to the decoration target without actually performing etching.

### BACKGROUND ART

Etching has been conventionally known as a decoration method for a decoration target such as metal or glass (refer to Japanese Unexamined Patent Application Publication (Translation of PCT Application) No. 2018-528911, for example). When etching is to be performed on the decoration target in an optional design, a mask having the shape of the design needs to be applied on the decoration target in advance before the etching on the decoration target. Typical methods of applying a mask on a decoration target include a method of affixing a cutout sticker or the like as the mask to the decoration target, and a method of forming a film as the mask on the decoration target by an ink-jet printer that uses resin ink such as UV ink. When the decoration target on which the mask is applied is immersed in etching solution such as ferric chloride aqueous solution after the mask is applied on the decoration target, a part at which the mask is applied on the surface of the decoration target is not corroded by the etching solution but remains as a smooth surface, but a part at which no mask is applied is corroded by the etching solution and becomes a matte surface on which minute irregularities are formed. After the immersion in the etching solution for an optional time, the decoration target on which the mask is applied is removed out of the etching solution and sufficiently cleaned with water. Lastly, the mask is removed from the decoration target.

Patent Literature 1: Japanese Unexamined Patent Application Publication (Translation of PCT Application) No. 2018-528911

### SUMMARY

However, the conventional decoration method needs a process of removing a mask from a decoration target, and thus work and technique are needed. For example, when the method of affixing a cutout sticker or the like as a mask to a decoration target is employed as the method of applying the mask to the decoration target, a process of peeling off the mask from the decoration target is needed, but the mask needs to be carefully peeled off from the decoration target without damaging the decoration target, and thus work and technique are needed. When the method of forming a film as a mask on a decoration target by an ink-jet printer is employed as the method of applying the mask to the decoration target, a process of scrubbing off the mask from the decoration target while the decoration target on which the mask is applied is immersed in a chemical such as alcohol is needed, and thus work and technique are needed.

In addition, in the conventional decoration method, etching solution such as ferric chloride aqueous solution is skin irritative and thus needs to be carefully handled, and cost and work are needed for disposal of the etching solution.

Thus, the present disclosure is intended to provide a pseudo etching decoration method and a pseudo etching decoration product in which decoration that appears as if a decoration target is etched can be provided to the decoration target without actually performing etching.

A pseudo etching decoration method according to the present disclosure includes: a first process of forming a pseudo etched part that is disguised as being etched by providing a matte-tone coating to a decoration target; and a second process of forming a pseudo unetched part that is not the pseudo etched part by providing gloss-tone printing by ink-jet printing on part of the coating provided to the decoration target in the first process.

With this configuration, among the surface of the decoration target, a part at which a gloss-tone film is formed becomes a smooth surface and serves as the pseudo unetched part, and a part at which no gloss-tone film is formed but the matte-tone coating is formed becomes a matte surface and serves as the pseudo etched part, and thus the pseudo etching decoration method according to the present disclosure can provide, to the decoration target without actually performing etching, decoration that appears as if the decoration target is etched.

In the pseudo etching decoration method according to the present disclosure, the decoration target may be made of at least one of glass, ceramic, resin, and metal.

With this configuration, among the surface of the decoration target made of at least one of glass, ceramic, resin, and metal, a part at which a gloss-tone film is formed becomes a smooth surface and serves as the pseudo unetched part, and a part at which no gloss-tone film is formed but the matte-tone coating is formed becomes a matte surface and serves as the pseudo etched part, and thus the pseudo etching decoration method according to the present disclosure can provide decoration that appears as if a decoration target is etched to the decoration target without actually performing etching.

In the pseudo etching decoration method according to the present disclosure, the second process may provide, by ink-jet printing with color ink, a pattern on part of the coating provided to the decoration target in the first process, and may provide gloss-tone printing with clear ink by ink-jet printing on the pattern.

With this configuration, the pseudo etching decoration method according to the present disclosure can easily provide color expression to the surface of the decoration product. In addition, since the pattern provided by ink-jet printing with color ink does not need to have a gloss tone, ink droplets do not need to be landed on all pixels of the pattern provided by ink-jet printing with color ink, and thus the pseudo etching decoration method according to the present disclosure can form the pattern in a light color.

In the pseudo etching decoration method according to the present disclosure, the second process may provide at least part of gloss-tone printing with color ink.

With this configuration, since the pattern provided by ink-jet printing with color ink has a gloss tone, the pseudo etching decoration method according to the present disclosure can form the pattern in a dense color by landing ink droplets on all pixels of the pattern provided by ink-jet printing with color ink. In addition, since the pattern provided by ink-jet printing with color ink has a gloss tone, clear ink does not need to be printed on the color ink, and thus the pseudo etching decoration method according to the present disclosure can facilitate manufacturing of the decoration product.

In the pseudo etching decoration method according to the present disclosure, the first process may provide the coating to the decoration target by spraying.

With this configuration, the pseudo etching decoration method according to the present disclosure can facilitate formation of the pseudo etched part.

A pseudo etching decoration product according to the present disclosure includes: a decoration target; a pseudo etched part that is formed of a matte-tone coating provided to the decoration target and is disguised as being etched; and a pseudo unetched part that is formed of a gloss-tone film provided on part of the coating and is not the pseudo etched part.

With this configuration, among the surface of the decoration target, a part at which a gloss-tone film is formed becomes a smooth surface and serves as the pseudo unetched part, and a part at which no gloss-tone film is formed but the matte-tone coating is formed becomes a matte surface and serves as the pseudo etched part, and thus in the pseudo etching decoration product according to the present disclosure, decoration that appears as if etching is performed on the decoration target can be provided to the decoration target without actually performing etching.

In a pseudo etching decoration method and a pseudo etching decoration product according to the present disclosure, decoration that appears as if a decoration target is etched can be provided to the decoration target without actually performing etching.

### BRIEF DESCRIPTION OF THE DRAWINGS

FIG. 1 is an external perspective view of an ink-jet printer used in a pseudo etching decoration method according to an embodiment of the present disclosure.

FIG. 2 is a plan view of a carriage of a printing unit illustrated in FIG. 1.

FIG. 3 is a block diagram of an ink-jet printer illustrated in FIG. 1.

FIG. 4 is a flowchart of a pseudo etching decoration method according to an embodiment of the present disclosure.

FIG. 5A is a plan view of an exemplary decoration target used in the pseudo etching decoration method illustrated in FIG. 4.

FIG. 5B is a schematic side view of the decoration target illustrated in FIG. 5A.

FIG. 6A is a plan view of an exemplary decoration target provided with a matte-tone coating by the pseudo etching decoration method illustrated in FIG. 4.

FIG. 6B is a schematic side view of the decoration target illustrated in FIG. 6A.

FIG. 7A is a plan view of an exemplary pseudo etching decoration product manufactured by the pseudo etching decoration method illustrated in FIG. 4,

FIG. 7B is a schematic side view of the pseudo etching decoration product illustrated in FIG. 7A.

FIG. 8A is a plan view of another exemplary pseudo etching decoration product manufactured by the pseudo etching decoration method illustrated in FIG. 4, which is different from the example illustrated in FIGS. 7A and 7B.

FIG. 8B is a schematic side view of the pseudo etching decoration product illustrated in FIG. 8A.

FIG. 9A is a plan view of another exemplary pseudo etching decoration product manufactured by the pseudo etching decoration method illustrated in FIG. 4, which is different from the examples illustrated in FIGS. 7 and 8.

FIG. 9B is a schematic side view of the pseudo etching decoration product illustrated in FIG. 9A.

### DESCRIPTION OF EMBODIMENTS

Embodiments of the present disclosure will be described below with reference to the accompanying drawings.

The configuration of an ink jet printer used in a pseudo etching decoration method according to the present embodiment will be first described.

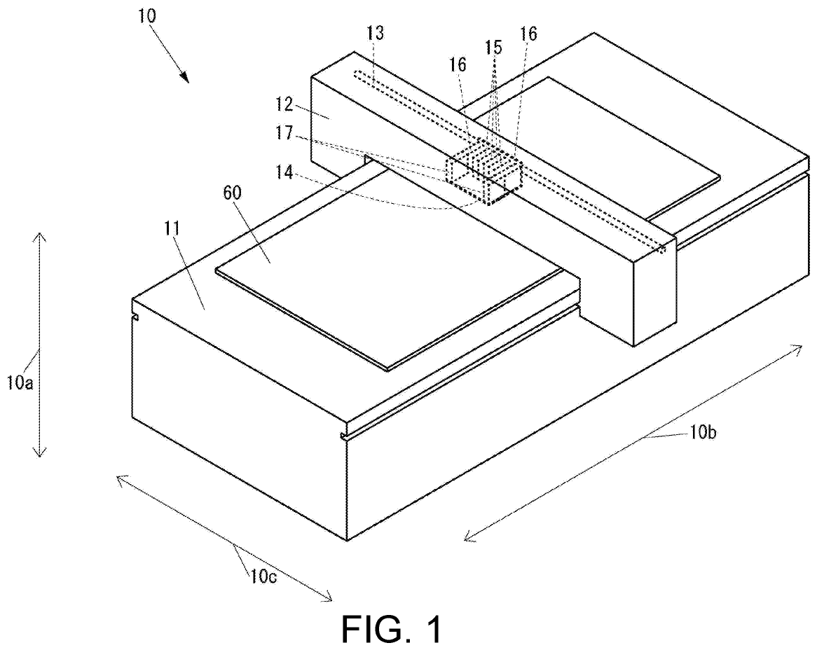

FIG. 1 is an external perspective view of an ink-jet printer 10 used in the pseudo etching decoration method according to the present embodiment.

As illustrated in FIG. 1, the ink jet printer 10 includes a flatbed 11 that can support, from the lower side in a vertical direction illustrated by an arrow 10a, a decoration target 60 to be decorated by the pseudo etching decoration method according to the present embodiment, and a printing unit 12 disposed on the upper side of the flatbed 11 in the vertical direction and supported to be movable relative to the flatbed 11 in a front-back direction (hereinafter referred to as “sub scanning direction”) illustrated by an arrow 10b orthogonal to the vertical direction. Relative movement of the flatbed 11 and the printing unit 12 in the sub scanning direction is executed by the printing unit 12 moving in the sub scanning direction in the present embodiment, but may be executed by the flatbed 11 moving in the sub scanning direction. The decoration target 60 may be made of at least one of, for example, glass, ceramic, resin, and metal.

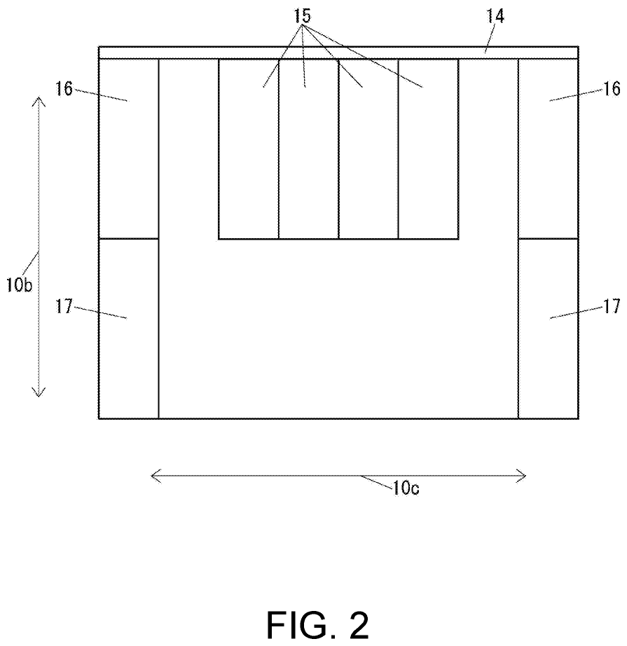

FIG. 2 is a plan view of a carriage 14 of the printing unit 12.

As illustrated in FIGS. 1 and 2, the printing unit 12 includes a rail 13 extending in a right-left direction (hereinafter referred to as “main scanning direction”) illustrated by an arrow 10c orthogonal to both the vertical direction and the sub scanning direction, the carriage 14, movement of which in the main scanning direction is guided by the rail 13, a plurality of ink-jet heads 15 configured to eject ink toward the decoration target 60 supported by the flatbed 11, a plurality of light irradiation devices 16 configured to emit light toward the ink adhering to the decoration target 60 supported by the flatbed 11, and a plurality of curing lamps 17 configured to emit light toward the ink adhering to the decoration target 60 supported by the flatbed 11. Relative movement of the flatbed 11 and the carriage 14 in the main scanning direction is executed by the carriage 14 moving in the main scanning direction in the present embodiment, but may be executed by the flatbed 11 moving in the main scanning direction.

The ink-jet heads 15, the light irradiation devices 16, and the curing lamps 17 are mounted on the carriage 14.

The ink ejected by the ink-jet heads 15 is ink to be cured through irradiation with light by the light irradiation devices 16 and is, for example, UV ink to be cured through irradiation with ultraviolet rays.

Each light irradiation device 16 is, for example, a device configured to emit ultraviolet rays through a light emitting diode (LED).

Each curing lamp 17 is, for example, a device configured to emit ultraviolet rays.

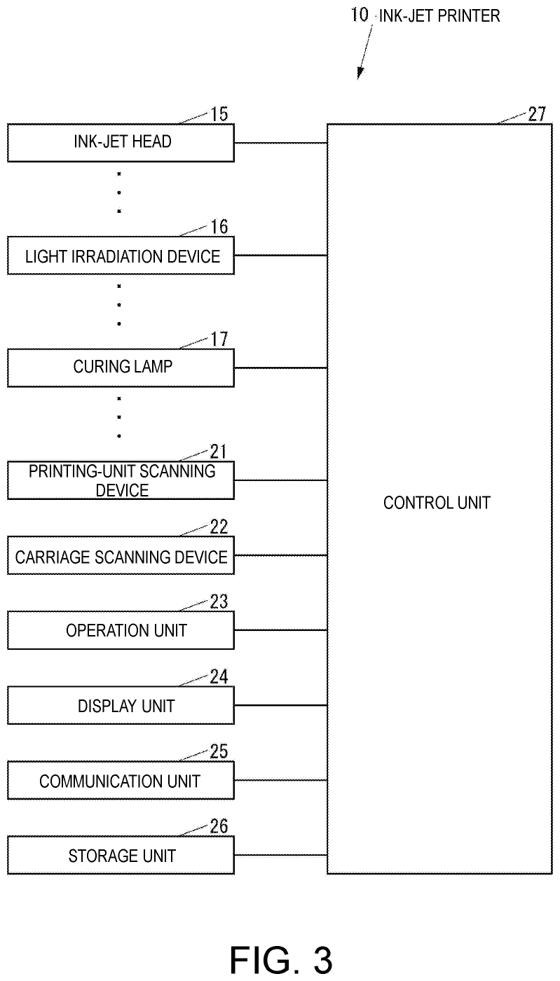

FIG. 3 is a block diagram of the ink-jet printer 10.

As illustrated in FIG. 3, the ink-jet printer 10 includes the ink-jet heads 15, the light irradiation devices 16, the curing lamps 17, a printing-unit scanning device 21 configured to move the printing unit 12 (refer to FIG. 1) relative to the flatbed 11 (refer to FIG. 1) in the sub scanning direction, a carriage scanning device 22 configured to move the carriage 14 (refer to FIG. 1) relative to the flatbed 11 in the main scanning direction along the rail 13 (refer to FIG. 1), an operation unit 23 that is an input device such as a button through which various kinds of operations are input, a display unit 24 that is a display device such as a liquid crystal display (LCD) configured to display various kinds of information, a communication unit 25 that is a communication device configured to directly perform communication with an external device in a wired or wireless manner through or not through a network, a storage unit 26 that is a non-transitory storage device such as a semiconductor memory or hard disk drive (HDD) configured to store various kinds of information, and a control unit 27 configured to control the entire ink-jet printer 10.

The control unit 27 includes, for example, a central processing unit (CPU), a read only memory (ROM) storing computer programs and various kinds of data, and a random access memory (RAM) used as a work area by the CPU of the control unit 27. The CPU of the control unit 27 executes computer programs stored in the ROM of the control unit 27 or the storage unit 26.

Subsequently, the pseudo etching decoration method according to the present embodiment will be described.

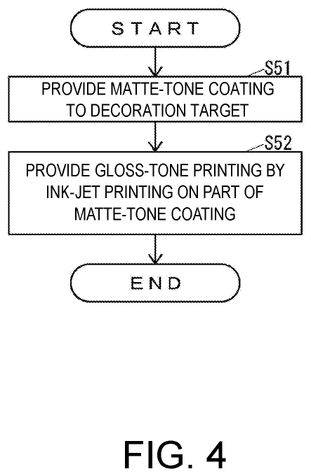

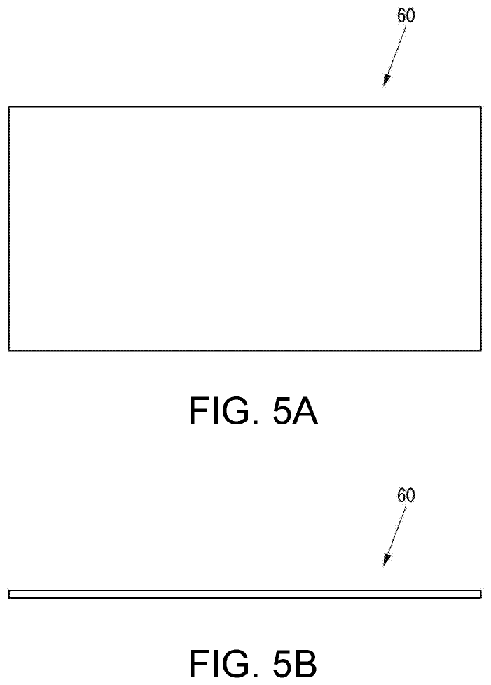

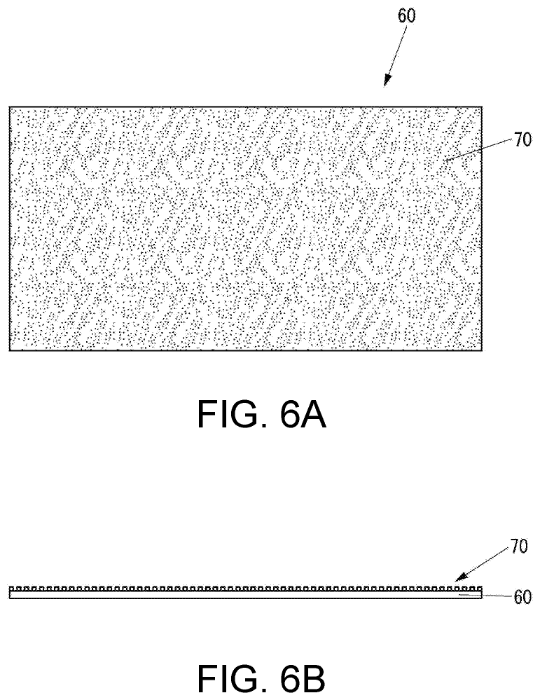

FIG. 4 is a flowchart of the pseudo etching decoration method according to the present embodiment. FIG. 5A is a plan view of an exemplary decoration target 60 used in the pseudo etching decoration method illustrated in FIG. 4. FIG. 5B is a schematic side view of the decoration target 60 illustrated in FIG. 5A. FIG. 6A is a plan view of an exemplary decoration target 60 provided with a matte-tone coating 70 by the pseudo etching decoration method illustrated in FIG. 4. FIG. 6B is a schematic side view of the decoration target 60 illustrated in FIG. 6A.

As illustrated in FIG. 4, the pseudo etching decoration method according to the present embodiment includes a process (S51) of forming a pseudo etched part disguised as being etched by providing the matte-tone coating 70 (refer to FIGS. 6A and 6B) to the decoration target 60 (refer to FIGS. 5A and 5B).

Exemplary methods of providing the matte-tone coating 70 to the decoration target 60 in the process at S51 include various kinds of methods such as screen printing, ink-jet printing, and spray coating.

For example, when the matte-tone coating 70 is provided to the decoration target 60 by a method other than a method of providing the matte-tone coating 70 to the decoration target 60 by matte-tone printing through UV ink-jet printing, such as a method of providing the matte-tone coating 70 to the decoration target 60 by ink-jet printing other than UV ink-jet printing, such as ink-jet printing with solvent ink, a method of providing the matte-tone coating 70 to the decoration target 60 by screen printing, or a method of providing the matte-tone coating 70 to the decoration target 60 by spray coating, ink or paint that is used needs to contain a filler for totaling minute irregularities on a surface to obtain a matte surface. The size of the filler is such that its diameter is, for example, several μm approximately.

When the matte-tone coating 70 is provided to the decoration target 60 by the method of providing the matte-tone coating 70 to the decoration target 60 by matte-tone printing through UV ink-jet printing, UV ink dots remain on the surface and form minute irregularities on the surface to form a matte surface, and thus UV ink that is used does not need to contain a filler. The size of each irregularity is such that, for example, its depth is smaller than 10 μm and its diameter is 50 to 80 μm.

For example, when the ink-jet printer 10 provides the matte-tone coating 70 to the decoration target 60 by matte-tone printing through UV ink-jet printing, the control unit 27 executes matte-tone printing on the decoration target 60 supported by the flatbed 11 based on printing data received through the communication unit 25.

The following specifically describes matte-tone printing by the ink-jet printer 10.

When the carriage 14 is moved in the main scanning direction by the carriage scanning device 22, the control unit 27 causes the ink-jet heads 15 to eject UV ink toward the decoration target 60 so that dots of the UV ink adhere onto the decoration target 60. In addition, when the carriage 14 is moved in the main scanning direction by the carriage scanning device 22, the control unit 27 causes the light irradiation devices 16 to emit, toward the dots of the UV ink adhering to the decoration target 60, ultraviolet rays at a sufficient intensity for sufficient curing to prevent deformation of the dots of the UV ink, in other words, for complete curing. Thus, the control unit 27 executes printing on the decoration target 60 by executing the ejection of UV ink toward the decoration target 60 by the ink-jet heads 15 and the emission of ultraviolet rays at an intensity for completely curing the UV ink by the light irradiation devices 16. Then, the control unit 27 changes the position of the carriage 14 relative to the decoration target 60 in the sub scanning direction as necessary by causing the printing-unit scanning device 21 to convey the printing unit 12 in the sub scanning direction, thereby executing printing on the decoration target 60 in the main scanning direction at a plurality of positions in the sub scanning direction.

The matte-tone coating 70 scatters light by minute irregularities, thereby providing a matte tone to the surface of the decoration target 60.

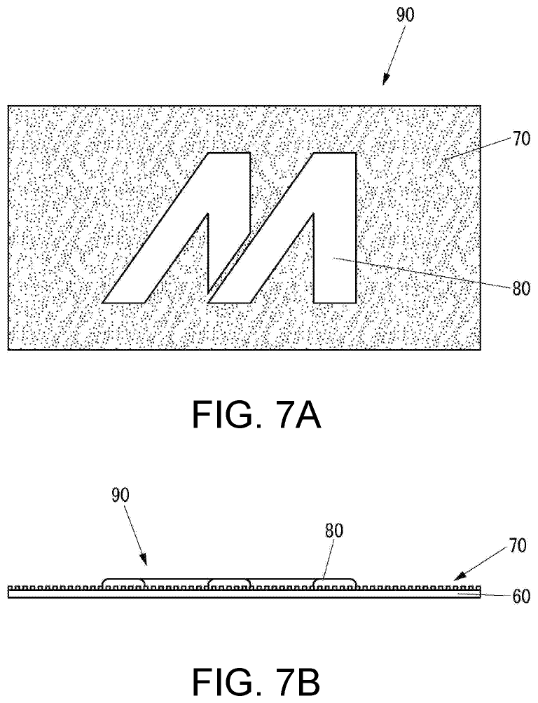

FIG. 7A is a plan view of an exemplary pseudo etching decoration product 90 manufactured by the pseudo etching decoration method illustrated in FIG. 4. FIG. 7B is a schematic side view of the pseudo etching decoration product 90 illustrated in FIG. 7A.

As illustrated in FIG. 4, the pseudo etching decoration method according to the present embodiment includes a process (S52) of forming a gloss-tone film 80 (refer to FIGS. 7A and 7B) of clear ink on part of the surface of the decoration target 60 by providing gloss-tone printing with clear ink by ink-jet printing on part of the matte-tone coating 70 provided to the decoration target 60 in the process at S51. In the process at S52, the gloss-tone film 80 provided on part of the matte-tone coating 70 forms a pseudo unetched part that is not the pseudo etched part.

In the process at S52, when the ink-jet printer 10 provides gloss-tone printing with clear ink by UV ink-jet printing on part of the matte-tone coating 70 on the decoration target 60, the control unit 27 executes gloss-tone printing on the decoration target 60 supported by the flatbed 11 based on printing data received through the communication unit 25.

The following specifically describes gloss-tone printing by the ink-jet printer 10.

When the carriage 14 is moved in the main scanning direction by the carriage scanning device 22, the control unit 27 causes the ink-jet heads 15 to eject UV ink toward the decoration target 60 so that dots of the UV ink adhere onto the matte-tone coating 70 on the decoration target 60. In addition, when the carriage 14 is moved in the main scanning direction by the carriage scanning device 22, the control unit 27 causes the light irradiation devices 16 to emit, toward the dots of the UV ink adhering onto the matte-tone coating 70 on the decoration target 60, ultraviolet rays at a low intensity for curing to prevent bleeding of the dots of the UV ink, in other words, temporarily curing. The dots of the UV ink do not bleed when temporarily cured but becomes flattened as time elapses, and when positioned adjacent to dots of other UV ink, the dots of the UV ink become coupled with the adjacent dots of the other UV ink. After the dots of the UV ink are temporarily cured on the matte-tone coating 70 on the decoration target 60, the control unit 27 causes the printing-unit scanning device 21 to convey the printing unit 12 in the sub scanning direction to a position where the temporarily cured UV ink can be irradiated with ultraviolet rays by the curing lamps 17, and causes the curing lamps 17 to emit, toward the UV ink temporarily cured on the matte-tone coating 70 on the decoration target 60, ultraviolet rays at an intensity sufficient for completely curing the UV ink while causing the carriage scanning device 22 to move the carriage 14 in the main scanning direction. Thus, the control unit 27 executes printing on the decoration target 60 by executing the ejection of the UV ink toward the decoration target 60 by the ink-jet heads 15, the emission of ultraviolet rays at an intensity for temporarily curing the UV ink by the light irradiation devices 16, and the emission of ultraviolet rays at an intensity for completely curing the UV ink by the curing lamps 17. Then, the control unit 27 changes the position of the carriage 14 relative to the decoration target 60 in the sub scanning direction as necessary by causing the printing-unit scanning device 21 to convey the printing unit 12 in the sub scanning direction, thereby executing printing on the decoration target 60 in the main scanning direction at a plurality of positions in the sub scanning direction.

When the gloss-tone film 80 of clear ink is formed, minute irregularities of the matte-tone coating 70 are filled with clear ink and thus do not scatter light any more, thereby not providing a matte tone to the surface of the decoration target 60.

The following describes examples of the pseudo etching decoration method according to the present embodiment.

### Example 1

The process at S51 provides the matte-tone coating 70 to a copper plate as the decoration target 60 by a spray coating agent such as B503 manufactured by GSI Creos corporation.

After the matte-tone coating 70 is dried for about one hour since the provision to the decoration target 60 in the process at S51, the process at S52 provides gloss-tone printing with clear ink by UV ink-jet printing on part of the matte-tone coating 70 provided to the decoration target 60.

### Example 2

The process at S51 provides the matte-tone coating 70 to a transparent acrylic plate as the decoration target 60 by a spray coating agent such as B503 manufactured by GSI Creos corporation.

After the matte-tone coating 70 is dried for about one hour since the provision to the decoration target 60 in the process at S51, the process at S52 provides gloss-tone printing with clear ink by UV ink-jet printing on part of the matte-tone coating 70 provided to the decoration target 60.

### Example 3

The process at S51 provides the matte-tone coating 70 to an aluminum plate as the decoration target 60 by a spray coating agent such as B503 manufactured by GSI Creos corporation.

After the matte-tone coating 70 is dried for about one hour since the provision to the decoration target 60 in the process at S51 the process at S52 provides gloss-tone printing with clear ink by UV ink-jet printing on part of the matte-tone coating 70 provided to the decoration target 60.

It is difficult to provide etching to aluminum, and thus alumite processing is typically performed to provide a matte tone to its surface. However in Example 3, among the surface of the decoration target 60 made of aluminum, a part at which the gloss-tone film 80 is formed becomes a smooth surface and serves as the pseudo unetched part, and a part at which no gloss-tone film 80 is formed but the matte-tone coating 70 is formed becomes a matte surface and serves as the pseudo etched part, and thus decoration that appears as if alumite processing is performed on the decoration target 60 can be provided to the decoration target 60 without actually performing alumite processing.

### Example 4

The process at S51 provides the matte-tone coating 70 to a transparent polycarbonate plate as the decoration target 60 by a spray coating agent such as B503 manufactured by GSI Creos corporation.

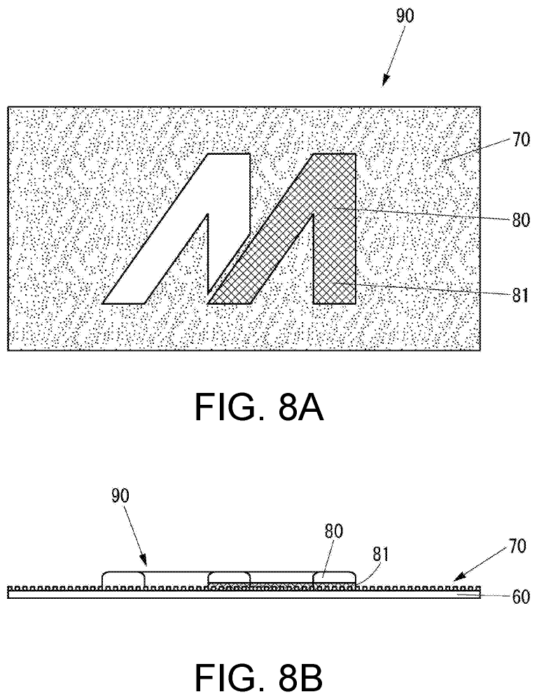

After the matte-tone coating 70 is dried for about one hour since the provision to the decoration target 60 in the process at S51, the process at S52 provides a pattern 81 by UV ink-jet printing with color ink on part of the matte-tone coating 70 provided to the decoration target 60 as illustrated in FIGS. 8A and 8B and provides gloss-tone printing with clear ink by UV ink-jet printing on the pattern 81, thereby forming the gloss-tone film 80 of clear ink on part of the surface of the decoration target 60.

It is difficult to provide color expression to the surface of a decoration product by a method of actually providing etching to the decoration target. However, in Example 4, color expression can be easily provided to the surface of the pseudo etching decoration product 90. In addition, in Example 4, since the pattern 81 does not need to have a gloss tone, ink droplets do not need to be landed on all pixels of the pattern 81, and thus the pattern 81 can be formed in a light color.

### Example 5

The process at S51 provides the matte-tone coating 70 to a transparent polycarbonate plate as the decoration target 60 by a spray coating agent such as B503 manufactured by GSI Creos corporation.

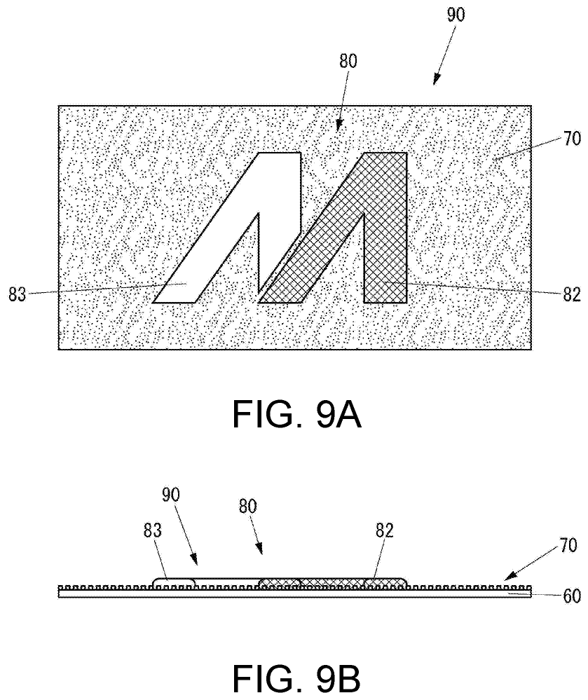

After the matte-tone coating 70 is dried for about one hour since the provision to the decoration target 60 in the process at S51, the process at S52 forms a color film 82 as part of the film 80 by providing gloss-tone printing with color ink by UV ink-jet printing on part of the matte-tone coating 70 provided to the decoration target 60 and also forms a clear film 83 as part of the film 80 by providing gloss-tone printing with clear ink by UV ink-jet printing on part of the matte-tone coating 70 provided to the decoration target 60 as illustrated in FIGS. 9A and 9B.

In Example 5, since a pattern formed by the color film 82 has a gloss tone, the pattern can be formed in a dense color by landing ink droplets on all pixels of a pattern provided by UV ink-jet printing with color ink. In addition, in Example 5, since a pattern formed by the color film 82 has a gloss tone, clear ink does not need to be printed on the color ink, and thus manufacturing of the pseudo etching decoration product 90 can be facilitated.

In Example 5, part of the film 80 is provided with color ink, but the entire film 80 may be provided with color ink.

As described above, among the surface of the decoration target 60, a part at which the gloss-tone film 80 is formed becomes a smooth surface and serves as the pseudo unetched part, and a part at which no gloss-tone film 80 is formed but the matte-tone coating 70 is formed becomes a matte surface and serves as the pseudo etched part, and thus the pseudo etching decoration method according to the present embodiment can provide, to the decoration target 60 without actually performing etching, decoration that appears as if etching is performed on the decoration target 60.

In addition, the pseudo etching decoration method according to the present embodiment can achieve, through a smaller number of processes than when etching is actually performed, decoration that appears as if etching is performed on the decoration target 60.

The pseudo etching decoration method according to the present embodiment can facilitate formation of the pseudo etched part when the process at S51 provides the coating 70 to the decoration target 60 by spraying.

What is claimed is:

1. A pseudo etching decoration method comprising:
a first process of forming a pseudo etched part that is disguised as being etched by providing a matte-tone coating to a decoration target; and
a second process of forming a pseudo unetched part that is not the pseudo etched part by providing a gloss-tone printing by ink-jet printing on a part of the matte-tone coating provided to the decoration target in the first process.

2. The pseudo etching decoration method according to claim 1, wherein the decoration target is made of at least one of glass, ceramic, resin, and metal.

3. The pseudo etching decoration method according to claim 1, wherein the second process comprises providing, by ink-jet printing with color ink, a pattern under the gloss-tone printing by ink-jet printing, and the gloss-tone printing is provided with clear ink by ink-jet printing on the pattern.

4. The pseudo etching decoration method according to claim 2, wherein the second process comprises providing, by ink-jet printing with color ink, a pattern under the gloss-tone printing by ink-jet printing, and the gloss-tone printing is provided with clear ink by ink-jet printing on the pattern.

5. The pseudo etching decoration method according to claim 1, wherein the second process provides at least a part of the gloss-tone printing with color ink.

6. The pseudo etching decoration method according to claim 2, wherein the second process provides at least a part of the gloss-tone printing with color ink.

7. The pseudo etching decoration method according to claim 1, wherein the first process provides the matte-tone coating to the decoration target by spraying.

8. The pseudo etching decoration method according to claim 2, wherein the first process provides the matte-tone coating to the decoration target by spraying.

9. The pseudo etching decoration method according to claim 3, wherein the first process provides the matte-tone coating to the decoration target by spraying.

10. The pseudo etching decoration method according to claim 4, wherein the first process provides the matte-tone coating to the decoration target by spraying.

11. The pseudo etching decoration method according to claim 5, wherein the first process provides the matte-tone coating to the decoration target by spraying.

12. The pseudo etching decoration method according to claim 6, wherein the first process provides the matte-tone coating to the decoration target by spraying.

13. A pseudo etching decoration product comprising:
a decoration target;
a pseudo etched part that is formed of a matte-tone coating provided to the decoration target and is disguised as being etched; and
a pseudo unetched part that is formed of a gloss-tone film provided on part of the matte-tone coating and is not the pseudo etched part.
